(19) United States
(12) Patent Application Publication
(10) Pub. No.: US 2016/0110952 A1
(43) Pub. Date: Apr. 21, 2016

(54) CASINO MEMBER MOBILE DEVICE SOFTWARE OPERATION SYSTEM

(71) Applicant: GAMA TECHNOLOGY LIMITED, Road Town (VG)

(72) Inventor: Shun-Tsung HSU, Taichung City (TW)

(21) Appl. No.: 14/518,816

(22) Filed: Oct. 20, 2014

(51) Int. Cl. G07F 17/32

(52) U.S. Cl. CPC G07F 17/3225

(57) ABSTRACT

A casino member mobile device software operation system to allow a player's mobile device to download a casino member mobile device software includes a mobile device software server, at least one human machine platform and a network exchanger. The mobile device software server stores the casino member mobile device software. The human machine platform has a Universal Serial Bus (USB) slot to allow the player to insert the mobile device to perform data transmission between the USB slot and the mobile device. The network exchanger is connected to the human machine platform and the mobile device software server to serve as a data transmission medium between the human machine platform and the mobile device software server. Thus the player can get the casino member mobile device software and operate a game operation console through the aid of the casino member mobile device software to meet use requirements.

### FIELD OF THE INVENTION

The present invention relates to a casino member management system and particularly to a casino member mobile device software operation system.

### BACKGROUND OF THE INVENTION

Casinos or gambling sites mainly provide various types of game machines or table games to allow players to choose as desired. To reduce manpower cost and malign collusion of people that might cause loss of the casinos casino management system has gradually evolved to total automation.

In order to enable players to easily know and understand functions of various facilities in the casino and how to log on and start games on various types of game machines, casino management unit often prepares and writes corresponding operation manuals and operation instructions. To facilitate browse of the players, some casinos have put the operation manuals in APP of mobile devices, hence the players can download the mobile device software to get the most updated operation manuals and operation instructions anytime desired.

However, the conventional mobile device software exists independently, i.e., does not link to various facilities in the casino. If the players want to get the mobile device software, in the present practice the players have to download and install the mobile device software. It is quite troublesome and inconvenient, this often results in lack of interest of the players to download the mobile device software.

### SUMMARY OF THE INVENTION

Therefore the primary object of the present invention is to provide a casino member mobile device software operation system to allow player's mobile device to download casino member mobile device software and aid operation of game operation console to meet use requirements.

Another object of the invention is to allow a player to execute game account registration process through a mobile device with the casino member mobile device software resided therein to improve usability.

To achieve the foregoing objects the present invention provides a casino member mobile device software operation system to allow a mobile device of a player to download a casino member mobile device software. It includes a mobile device software server, at least one human machine platform and a network exchanger. The mobile device software server stores the casino member mobile device software. The human machine platform has a Universal Serial Bus (USB in short hereinafter) slot to allow the player to insert the mobile device to perform data transmission between the USB slot and the mobile device. The network exchanger is connected to the human machine platform and the mobile device software server to serve as a data transmission medium between the human machine platform and the mobile device software server.

The player also can do registration process of a game account of a game machine through the mobile device loaded with the casino member mobile device software. The game machine includes a game operation console which has a registration process unit and a display interface. The operation system of the invention includes a human machine platform which has a data transmission interface to link the mobile device so that the data transmission interface and the mobile device can perform data transmission between them. The registration process unit gets a player's account data through the data transmission interface and the casino member mobile device software in the mobile device to check whether the player's account data is correct, and displays the player's account data on the display interface.

Thus, because the USB slot of the human machine platform can be connected with the player's mobile device, and the human machine platform also can be linked to the mobile device software server through the network exchanger, the mobile device can get the casino member mobile device software, and the player can choose whether to install the casino member mobile device software.

In addition, the system of the invention also allows the player to execute game account registration process through the mobile device loaded with the casino member mobile device software. The human machine platform has a data transmission interface to perform data transmission with the mobile device, and at the same time get player's account data through the casino member mobile device software to check whether the account data is correct. Hence the operation system of the invention can aid the player to operate the game operation console to meet use requirements.

The foregoing, as well as additional objects, features and advantages of the invention will be more readily apparent from the following embodiments and detailed description, which proceed with reference to the accompanying drawings. The embodiments merely serve for illustrative purpose and are not the limitation of the invention.

### BRIEF DESCRIPTION OF THE DRAWINGS

FIG. 1 is a system block diagram of the invention.

FIG. 2 is a system block diagram of another embodiment of the invention.

FIG. 3 is a schematic view of the game operation console of the invention in implementation.

FIG. 4 is a schematic view of the charging station of the invention in implementation.

FIG. 5 is a system block diagram of yet another embodiment of the invention.

### DETAILED DESCRIPTION OF THE PREFERRED EMBODIMENTS

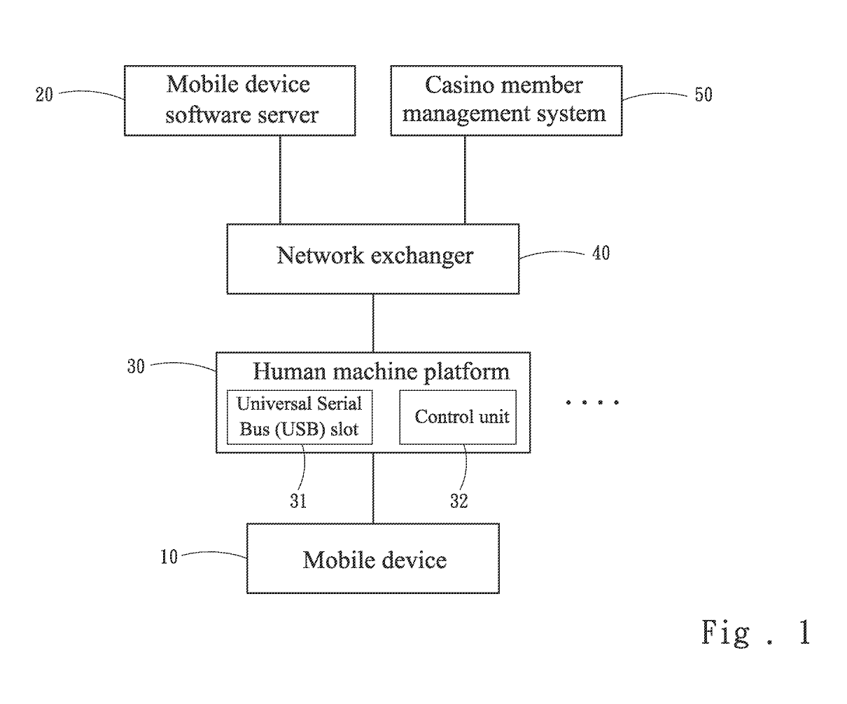

Please referring to FIG. 1, the present invention aims to provide a casino member mobile device software operation system to allow a player to download a casino member mobile device software in a mobile device 10. The mobile device 10 includes various types of smart devices, such as smartphones, tablet computers, smart wearing devices or the like.

The operation system of the invention includes a mobile device software server 20, at least one human machine platform 30 and a network exchanger 40. The mobile device software server 20 stores the casino member mobile device software. The human machine platform 30 has a USB slot 31 to allow the player to insert the mobile device 10 to perform data transmission between the USB slot 31 and the mobile device 10. The network exchanger 40 is connected to the human machine platform 30 and the mobile device software server 20 to serve as a data transmission medium between the human machine platform 30 and the mobile device software server 20.

The network exchanger 40 further can be connected to a casino member management system 50 to allow the player to log on the casino member management system 50 through the human machine platform 30 to directly use functions provided by the casino member management system 50 to improve usability.

When the invention is in use, the human machine platform 30 can further include a control unit 32 to detect whether the USB slot 31 is connected with the mobile device 10. If the connection of the mobile device 10 is detected, a message is transmitted to the mobile device 10 and displayed thereon to inquire whether to download the casino member mobile device software; namely after the mobile device 10 has been inserted into the UBS slot 31 the message of inquiring whether to download the casino member mobile device software is displayed on the screen of the mobile device 10; after positive confirmation, the casino member mobile device software is downloaded to the mobile device 10.

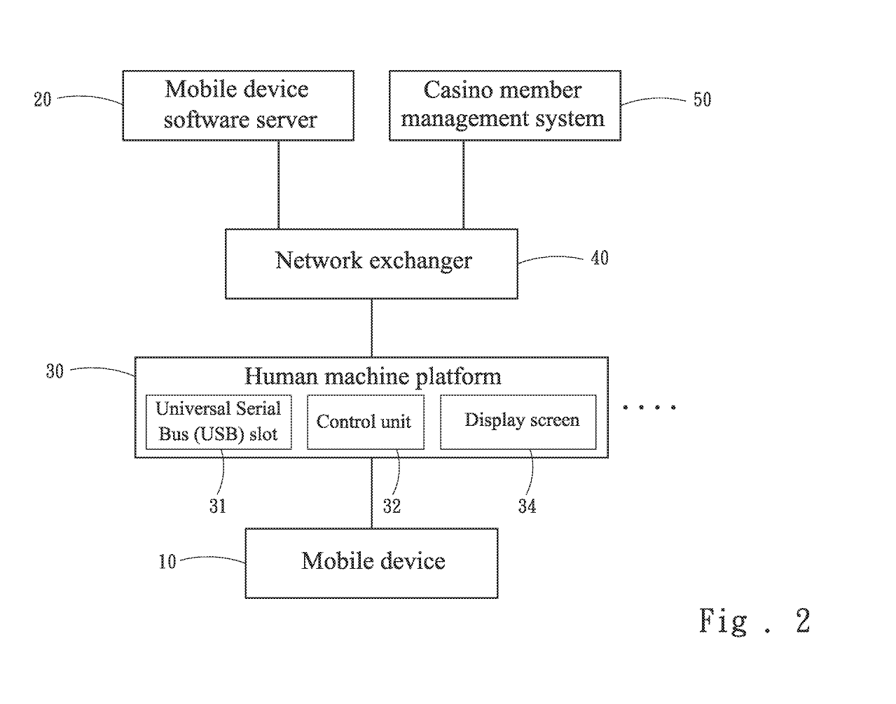

Please refer to FIG. 2 for another embodiment of the invention. In this embodiment the human machine platform 30 further includes a control unit 32 and a display screen 34. The control unit 32 aims to detect whether the USB slot 31 is connected with the mobile device 10. After the mobile device 10 has been inserted into the USB slot 31 the display screen 34 displays detection of the mobile device 10 and inquires whether to download the casino member mobile device software to the mobile device 10. It differs from the previous embodiment by directly making inquiry on the display screen 34 about whether to download the casino member mobile device software, namely control of the mobile device 10 has been transferred to the human machine platform 30, and the player can directly determine on the human machine platform 30 whether to download the casino member mobile device software.

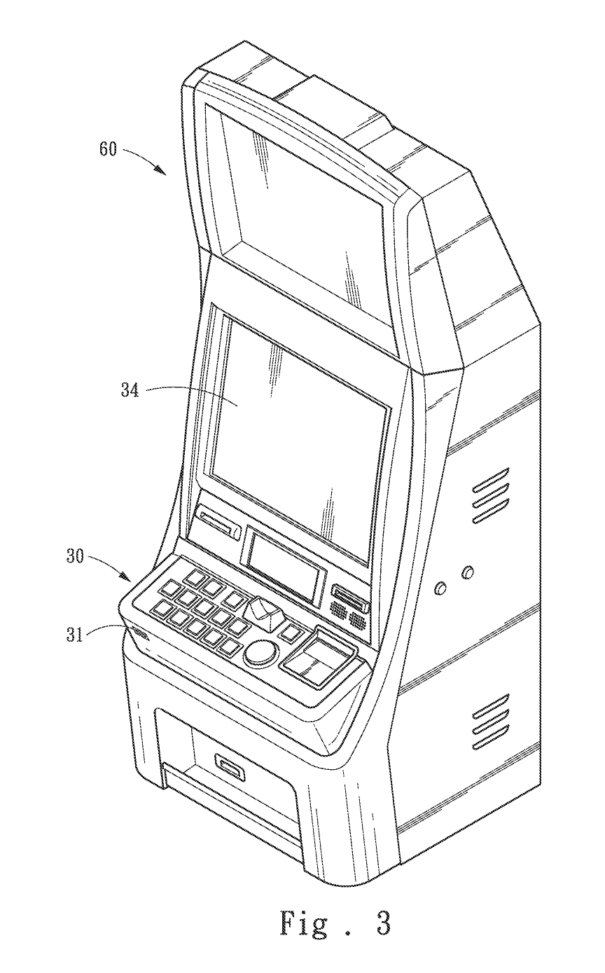

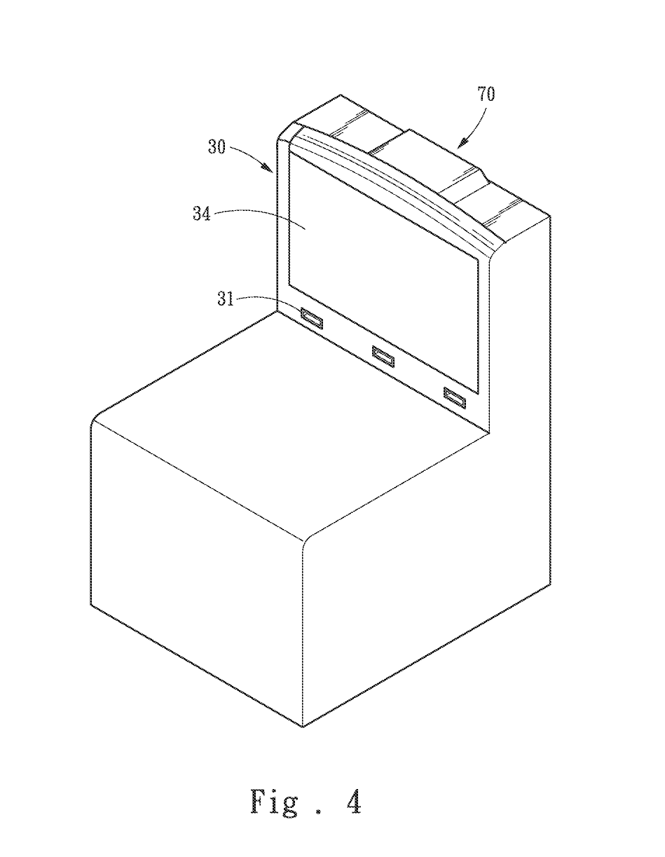

Please referring to FIG. 3, the human machine platform 30 can be located on a game operation console 60, or referring to FIG. 4, the human machine platform 30 can also be located on a charging station 70. In FIGS. 3 and 4, the human machine platform 30 equipped with the display screen 34 is shown to represent an implementation approach. It also can be implemented without the display screen 34. It is to be noted that the game operation console 60 also can be used to operate a game machine (not shown in the drawings), while the charging station 70 can be used to charge the mobile device 10.

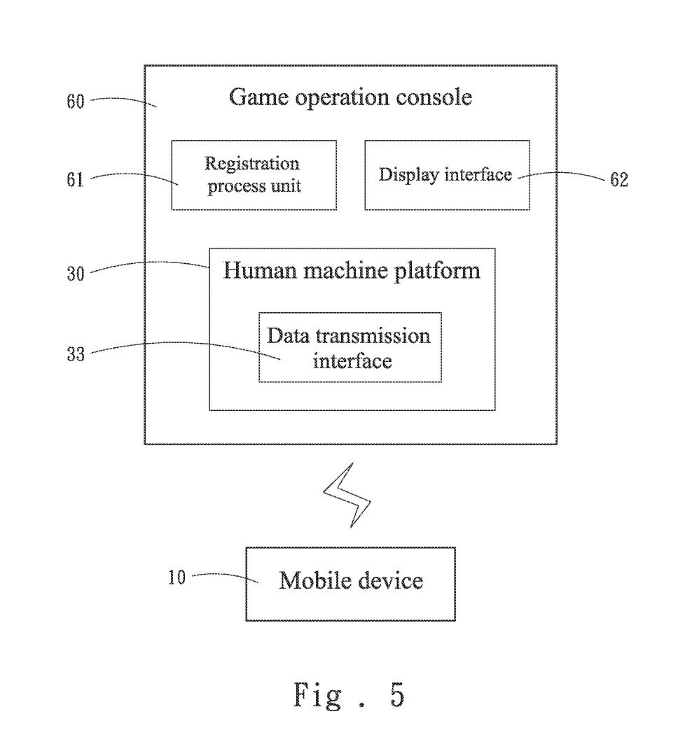

Please refer to FIG. 5 for yet another embodiment of the invention. It allows the player to perform registration process of a game account in a game machine through the mobile device 10 loaded with the casino member mobile device software. The game machine includes a game operation console 60 which has a registration process unit 61 and a display interface 62. The system of the invention includes a human machine platform 30 which can be located on the game operation console 60.

The human machine platform 30 also has a data transmission interface 33 which can be selectively a line transmission interface or a short distance wireless transmission interface, namely the data transmission interface 33 can be a USB to allow the player to insert the mobile device 10. The data transmission interface 33 also can be selected from the group consisting of Bluetooth, infrared transmission, Zigbee technique, ultra-wideband (UWB), HomeRF, WiMax, Wi-Fi and wireless radiation frequency technique.

The data transmission interface 33 is linked to the mobile device 10 to perform data transmission between them. The registration process unit 61 gets a player's account data through the data transmission interface 33 and the casino member mobile device software in the mobile device 10, then the registration process unit 61 checks whether the player's account data is correct, and displays the player's account data on the display interface 62.

As a conclusion, the USB slot 31 of the invention can receive insertion of the player's mobile device 10, and the human machine platform 30 can be linked to the mobile device software server 20 with the casino member mobile device software stored therein through the network exchanger 40, and also perform detection through the control unit 32. When the mobile device 10 is inserted into the USB slot 31, an inquiry is made to ask the player whether to download the casino member mobile device software, then the player's mobile device 10 can receive download of the casino member mobile device software as desired.

The system provided by the invention also allows the mobile device 10 loaded with casino member mobile device software to execute registration process of game account. Through the casino member mobile device software in the mobile device 10 player's account data can be gotten to check its correctness. Thereby the operation system of the invention allows the player's mobile device 10 to download the casino member mobile device software, also aid the player to play the game operation console 60 via the casino member mobile device software at the same time, thus can meet use requirements.

What is claimed is:

1. A casino member mobile device software operation system to allow a player to download a casino member mobile device software into a mobile device, comprising:
a mobile device software server to store the casino member mobile device software;
at least one human machine platform including at least one universal serial bus slot to allow the player to insert the mobile device to perform data transmission between the universal serial bus slot and the mobile device; and
a network exchanger connected to the human machine platform and the mobile device software server to serve as a data transmission medium between the human machine platform and the mobile device software server.

2. The casino member mobile device software operation system of claim 1, wherein the network exchanger is further connected to a casino member management system to allow the player to log on the casino member management system through the human machine platform.

3. The casino member mobile device software operation system of claim 1, wherein the human machine platform further includes a control unit to detect whether the mobile device is inserted into the universal serial bus slot, and send a message to the mobile device to be displayed thereon after the insertion is detected.

4. The casino member mobile device software operation system of claim 3, wherein the message is inquiring whether to download the casino member mobile device software to the mobile device.

5. The casino member mobile device software operation system of claim 3, wherein the human machine platform is located on a game operation console.

6. The casino member mobile device software operation system of claim 3, wherein the human machine platform is located on a charging station.

7. The casino member mobile device software operation system of claim 1, wherein the human machine platform further includes a control unit and a display screen, the control unit detecting whether the mobile device is inserted into the universal serial bus slot, and displaying the detected mobile device on the display screen after the insertion is detected, and inquiring whether to download the casino member mobile device software to the mobile device.

8. The casino member mobile device software operation system of claim 7, wherein the human machine platform is located on a game operation console.

9. The casino member mobile device software operation system of claim 7, wherein the human machine platform is located on a charging station.

10. A casino member mobile device software operation system to allow a player to download a casino member mobile device software into a mobile device to perform registration process of a game account of a game machine, the game machine including a game operation console which includes a registration process unit and a display interface, comprising:
a human machine platform which includes a data transmission interface linked to the mobile device to perform data transmission between the data transmission interface and the mobile device, the registration process unit getting a player's account data through the data transmission interface and the casino member mobile device software in the mobile device, and checking correctness of the player's account data and displaying the player's account data on the display interface.

11. The casino member mobile device software operation system of claim 10, wherein the data transmission interface is selectively a line transmission interface or a short distance wireless transmission interface.

12. The casino member mobile device software operation system of claim 11, wherein the data transmission interface is a universal serial bus to allow the player to insert the mobile device.

13. The casino member mobile device software operation system of claim 11, wherein the data transmission interface is selected from the group consisting of Bluetooth, infrared transmission, Zigbee technique, ultra-wideband, HomeRF, WiMax, Wi-Fi and wireless radiation frequency technique.

14. The casino member mobile device software operation system of claim 10, wherein the human machine platform is located on the game operation console.
